(19) United States
(12) Patent Application Publication
(10) Pub. No.: US 2015/0353776 A1
(43) Pub. Date: Dec. 10, 2015

(54) ADHESION OF MODIFIED ADHESIVE TAPE TO FOAM AND OTHER SUBSTRATES

(71) Applicant: Owens Corning Intellectual Capital, LLC, Toledo, OH (US)

(72) Inventor: Matthew Daniel Gawryla, Chagrin Falls, OH (US)

(21) Appl. No.: 14/729,293

(22) Filed: Jun. 3, 2015

Related U.S. Application Data
(60) Provisional application No. 62/008,548, filed on Jun. 6, 2014.

(51) Int. Cl. C09J 7/02; B32B 37/12

(52) U.S. Cl. CPC C09J 7/02; B32B 37/12; B32B 2307/50

(57) ABSTRACT

An improved adhesive system used to seal the joints between substrates such as foam insulation boards is provided. The system includes an adhesive tape used to achieve an air and moisture barrier between the joints of expanded polystyrene foam boards.

### RELATED APPLICATION

The present application claims the benefit of U.S. provisional patent application No. 62/008,548, filed on Jun. 6, 2014, titled “ADHESION OF BUTYL-BASED ADHESIVE TAPE TO FOAM AND OTHER SUBSTRATES”. U.S. provisional patent application No. 62/008,548 is incorporated herein by reference in its entirety.

### FIELD OF THE DISCLOSURE

The present disclosure relates generally to an improved adhesive system used to seal the joints between substrates such as foam insulation boards. Particularly, the present disclosure relates to an adhesive tape that provides an air and moisture barrier for extruded polystyrene foam boards. It will be appreciated, however, that the invention is also amenable to other applications.

### BACKGROUND

In constructing a building, and in particular a house, a relatively thin panel board is commonly used to cover the structural framework of exterior walls. The board is typically fabricated from a low-cost, lightweight material having enhanced insulating properties, such as, for example, extruded or expanded polystyrene, polyisocyanuarate, or polyurethane foam. Usually, the boards are sized for use in conjunction with conventional frame selections (that is, frames with wooden studs on 16 inch (40.64 cm) or 24 inch (60.96 cm) centers). The boards may also have varying thickness and compositions, depending on, among other considerations, the desired resistance to heat flow.

In some applications, an air and water or moisture barrier is provided between the interior and the exterior of the building. Generally, the barrier system is configured to “seal” the entire structure. This air and moisture barrier may be achieved using a layer of a plastic sheet known as a water resistive barrier in conjunction with the boards. In the alternative, the air and moisture barrier may also be achieved by affixing an adhesive carrier such as tape over the joints where the boards abut one another.

### SUMMARY

Various exemplary embodiments of the present invention are directed to a system and method for achieving improved adhesion between an adhesive carrier and an extruded polystyrene foam insulation board. The system and method for improving adhesion disclosed herein includes a butyl-based adhesive affixed to an adhesive carrier at a thickness of less than or equal to about 5 mil.

In accordance with some exemplary embodiments, a method of providing an air and moisture barrier system is provided. The method comprises applying a butyl-based adhesive to a carrier material to form an adhesive carrier, wherein the butyl-based adhesive is applied in a thickness of less than or equal to about 5 mil, and further providing a plurality of extruded polystyrene foam insulation boards. The method further comprises affixing the adhesive carrier to seal at least one side of each extruded polystyrene foam insulation board to one side of at least one other extruded polystyrene foam insulation board.

In accordance with some exemplary embodiments, a system for achieving improved adhesion between an adhesive carrier and an extruded polystyrene foam insulation board is provided. The system comprises an extruded polystyrene foam board and an adhesive carrier bonded to a surface of the extruded polystyrene foam board, wherein the adhesive carrier comprises a butyl-based adhesive layer affixed to a carrier material, and wherein the butyl-based adhesive layer has a thickness of less than or equal to about 5 mil.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a front view illustrating an assembly of boards and joint tape in accordance with one embodiment disclosed herein;

FIG. 2 is a front view illustrating an assembly of boards and joint tape in accordance with one embodiment disclosed herein;

FIG. 3 is an illustration of an exemplary embodiment of an extruded polystyrene board;

FIG. 4 is an illustration of the peel strength of a conventional butyl adhesive system at various adhesive thickness ranges.

FIGS. 5-7 are illustrations of an adhesive tape peeled from varying substrates in accordance with certain adhesive systems disclosed herein.

FIG. 8 is an illustration of the relationship between the concentration of crosslinking agent in an adhesive system and the shear strength on foam.

FIG. 9 is an illustration of the relationship between the concentration of crosslinking agent in an adhesive system and the peel strength on foam.

FIG. 10 is an illustration of the relationship between the concentration of tackifier in an adhesive system and the peel strength on foam.

### DETAILED DESCRIPTION OF THE DISCLOSURE

An improved adhesive system to seal the joints between substrates such as foam insulation boards via a carrier such as tape is described in detail herein. The adhesive system may be in the form of a tape having a low coat weight adhesive. The adhesive tape provides an air and moisture barrier when applied to the seams of fragile substrates such as extruded polystyrene foam boards. These and other features of the adhesive system, as well as some of the many optional variations and additions, are described in detail hereafter.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements.

All references to singular characteristics or limitations of the present disclosure shall include the corresponding plural characteristic or limitation, and vice versa, unless otherwise specified or clearly implied to the contrary by the context in which the reference is made.

The foam boards and adhesive tape disclosed herein can be used in a wide variety of applications. In one exemplary embodiment, the foam boards may be used as sheathing boards that are applied to outer studs, joists, rafters, and other frame members of a building. The foam boards may alternatively be used as panels on the interior of a building, or in a variety of other applications.

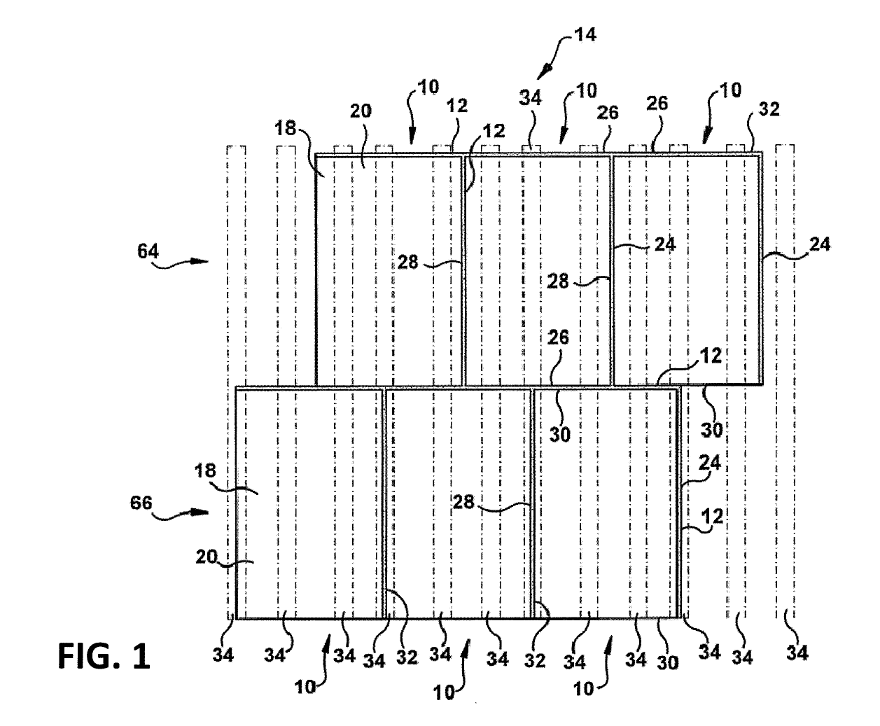

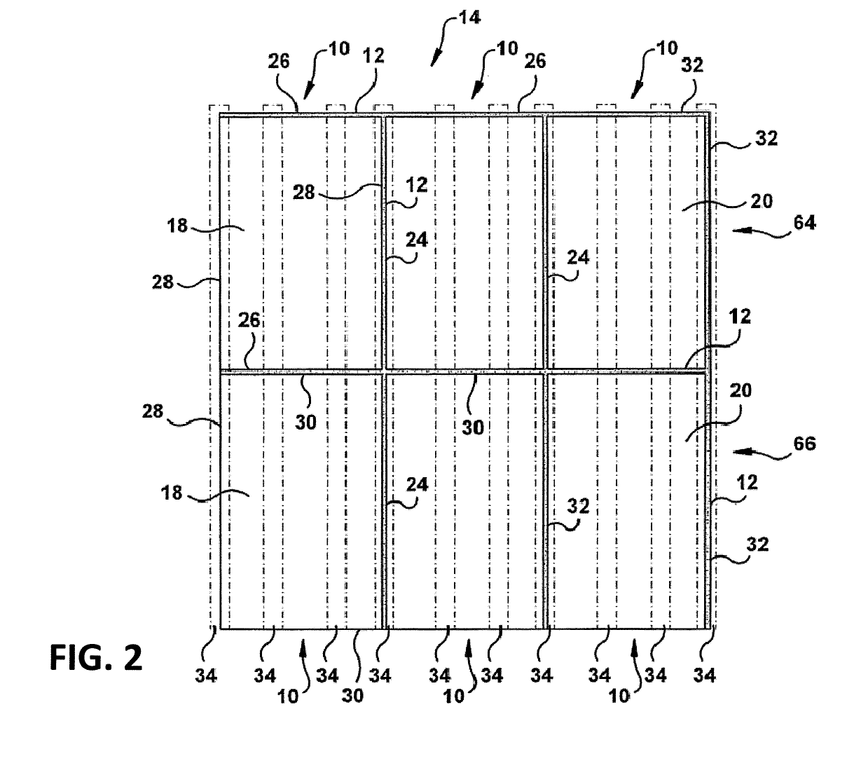

FIGS. 1 and 2 illustrate an exemplary embodiment of a method 16 for installing foam boards 110 with adhesive tape 12 to form a sealed sheathing system 14. The board 10 is positioned on the frame 34. Adhesive tape 12 is used to seal gaps between adjacent boards 10. In some embodiments, the adhesive tape 12 forms an air tight seal between each board 10. The boards 10 may be assembled to the frame 34 with conventional fasteners, such as staples, nails, screws, and/or adhesive. Each board 10 is positioned adjacent to one or more other boards and is then fastened to the frame members 34. The secured boards are then taped to seal the interfaces or abutments between the boards. The frame members 34 may take a variety of forms. For example, the frame 34 may comprise conventional wood or metal framing studs that are typically used to frame houses and other buildings. Any type of material capable of supporting the boards 10 may be used. This process may be repeated as many times as necessary to form a system 14 that acts as an air and moisture barrier between the inside and outside of a building. In some embodiments, the boards 10 may be taped with the adhesive tape 12 to seal a joint on one side, two sides, three sides, or four sides of the boards.

The boards 10 may be made from a wide variety of different materials and combinations of materials. Examples include, but are not limited to, foam materials such as polystyrene, extruded polystyrene, expanded polystyrene, molded polystyrene, polyisocyanurate, polyurethane with a reinforcement skin laminated on one or both sides, and composite materials, such as a composite of any one or more of oriented strand board (OSB), plywood, and of the foam materials listed above, fiberglass reinforced sheets, the sheathing material that is described in U.S. Pat. No. 6,715,249 to Rusek et al. (which is incorporated herein by reference in its entirety). The boards may comprise any product capable of being provided in a rigid or semi-rigid sheet or board form.

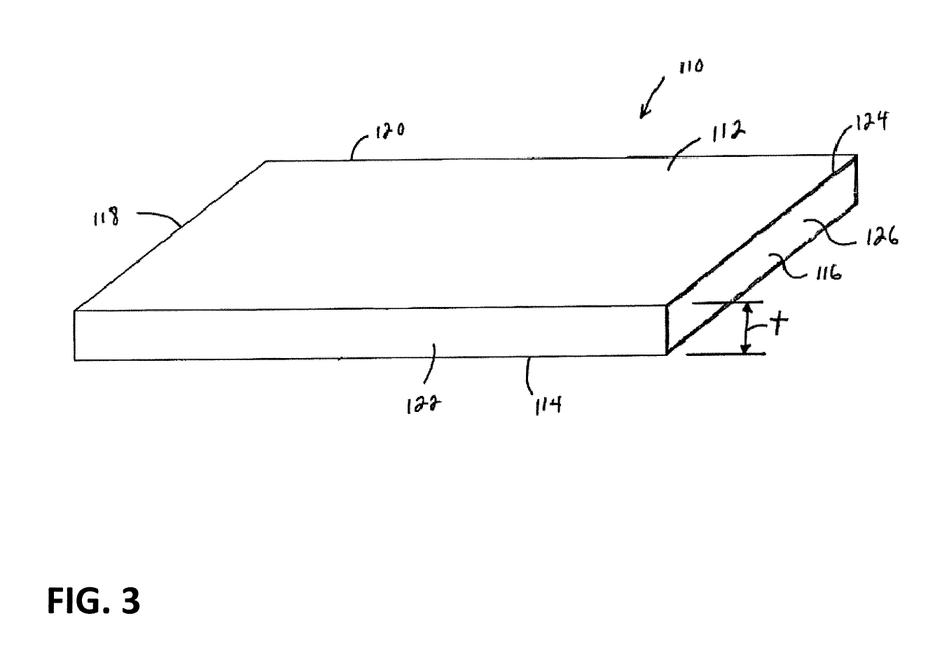

FIG. 3 illustrates an exemplary embodiment of a foam board 110, such as an extruded polystyrene board. In some exemplary embodiments, the foam board 110 is a polystyrene foam board, such as an extruded polystyrene foam board or an expanded polystyrene foam board. The illustrated foam board 110 is rectangular with first and second major face surfaces 112, 114, spaced apart by a thickness t. The foam board 110 has side edges 116, 118, 120, 122 that extend between the first and second major surfaces 112, 114. Both of the major surfaces 112, 114 may comprise a skin 124 that is formed during the extrusion process. The extrusion skin 124 is a stratum of polystyrene material that is denser than the interior foamed portion 126 of the board. That is, the thin extrusion skin is substantially solid whereas the foamed portion 126 comprises expanded foam cells. Examples of suitable foam boards 110 include the FOAMULAR® Extruded Polystyrene Insulation products that are available from Owens Corning.

In one embodiment, it is contemplated that the foam boards 110 are engineered extruded polystyrene (XPS) foams having a molecular weight of between about 100,000 to about 350,000. In one embodiment, the foam boards 110 have a molecular weight of between about 120,000 and about 150,000 from recycled expanded polystyrene. However, other foams are also contemplated in other embodiments. It is also contemplated that the foam boards 110 are sized to between about 600 mm to about 1524 mm wide×about 1200 mm to about 2769 mm long. The boards are also contemplated to be any sheet stock made of any thermoplastic polymer material.

It should be understood that the term “adhesive tape” 12 as used herein is not intended to limit the carrier material 400 for the adhesive 402. The carrier material 400 may include any material sufficient to carry the adhesive 402 onto the desired board or substrate. In some exemplary embodiments, the adhesive tape 12 is formed from the combination of an adhesive 402 and a polymeric film material 400. In other exemplary embodiments, the adhesive carrier 400 may include any of a foil, paper, woven, nonwoven, veil, mat, or glass scrim. In some exemplary embodiments, the adhesive 400 and carrier 402 form a “joint tape” 12 product for foam insulation boards.

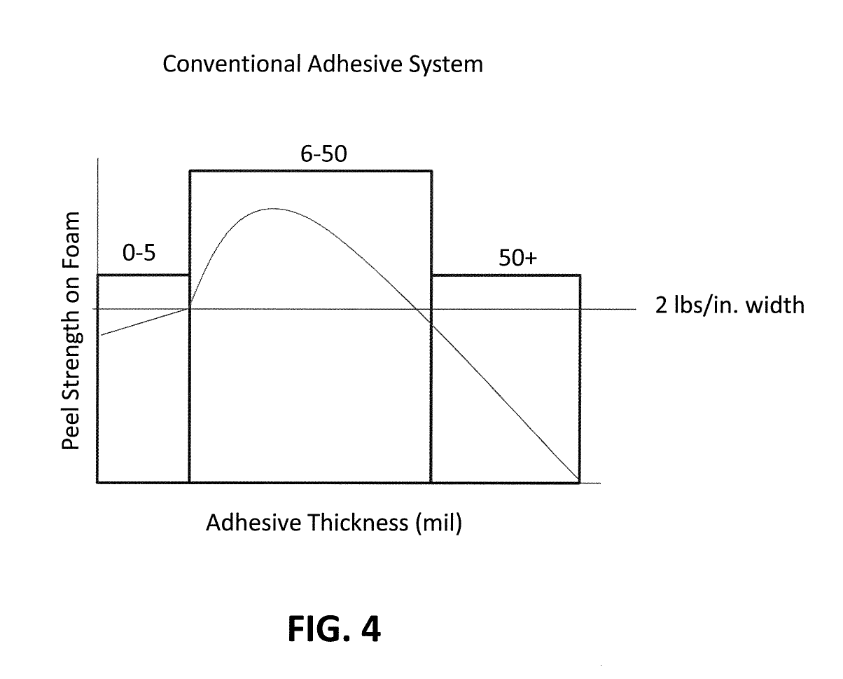

Securing the boards 10 to the frame members 34 permanently sets the relative positions of the boards 10. The adhesive tape 12 would also remain permanently affixed forming the seal between each board 10. However, stress may be placed on the tape 12, causing the tape to potentially peel away from the board 10. For example, stress may be applied to the tape 12 by relative movement of the boards 10, due to, for example, setting of the building, wind, earthquakes, etc. Adhesives 402 are typically selected to provide a strong, rigid bond between the carrier 400 and the board 10. The carrier 400 is typically selected to be flexible and allow for some relative movement between the boards 10 without peeling. However, in applications where the board 10 is made from foamed plastic, the skin 124 may fail before the adhesive bond between the carrier 400 and the skin 124 fails (see FIG. 6). This failure is due to the mechanical integrity of the relatively “weak” connection between the skin 124 and the foam 126 failing before the adhesive fails. Conventional applications have attempted to overcome this tendency by increasing the thickness of the adhesive on the adhesive carrier to provide the requisite force displacement to increase the amount of peel strength. As shown in FIG. 4, a conventional adhesive must be applied at a thickness from 6 to 50 mil to achieve a desirable peel strength.

The adhesive tape 12 disclosed herein achieves an improved adhesion and measured peel value without an increase in adhesive thickness. Rather, the adhesive has a low coat weight, which unexpectedly improves the adhesion of the tape to foam. The adhesive disclosed herein may be any adhesive suitable to seal the joints between foam insulation boards. In some exemplary embodiments, the adhesive is a butyl adhesive. However, the adhesive system is not limited to this embodiment, and may include any suitable adhesive including, for example, an acrylic-based adhesive system. In some exemplary embodiments, the adhesive is applied to the carrier in a thickness of less than or equal to about 5 mil. In some exemplary embodiments, the thickness of the adhesive on the carrier is from about 1 mil to about 5 mil, or from about 3 mil to about 5 mil. This is a sharp contrast to conventional applications utilizing a butyl adhesive applied in a thickness between 15 and 20 mil.

In some embodiments, the adhesive 402 may be applied to the carrier material 400 via either a hot melt or solvent casting application. In a hot melt process, the adhesive 402 is heated to a temperature at which is flows freely and is forced through a die to create a uniformly thick layer. The uniformly thick layer is then placed onto a substrate which could be the carrier material 400. An alternative method is to dissolve the adhesive in a solvent and use a liquid coating technique to transfer the adhesive solution in a uniformly thick layer to a substrate. After the adhesive solution is applied to the substrate, the solvent is allowed to evaporate, commonly in an oven, to form a uniform layer of pure adhesive that is free of solvent. In some embodiments, the uniformly thick adhesive or adhesive solution is placed on a substrate that is not the carrier, and at a later step the exposed adhesive is laminated to the carrier material 400. However, the adhesive 402 may be applied to the carrier material in a wide variety of different ways.

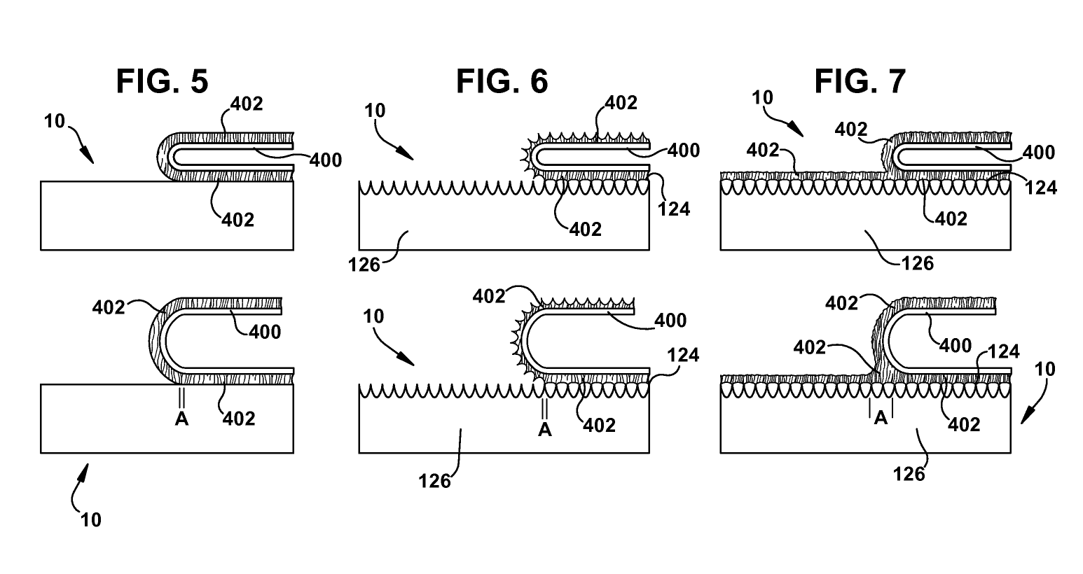

FIGS. 5 through 7 illustrate the improved adhesive system disclosed herein as compared to conventional adhesive systems. FIG. 5 shows an adhesive tape peeled away from a solid, relatively nonporous substrate such as plywood or solid plastic. As the adhesive is pulled or peeled from the nonporous substrate, the area A of force application is a thin line across the width of the sample. This is because the bond strength of the adhesive is high, and the cured adhesive is unyielding. FIGS. 6 and 7 illustrate adhesive tapes 12 peeled away from a porous, fragile substrate such as foam board. In FIG. 6, a conventional adhesive tape is adhered to the skin 124 of the foam board 10. As such, the area A of force application that results from pulling or peeling the tape away from the foam board 10 is substantially the same as in FIG. 5, where the board is wood or solid plastic. In this conventional embodiment, the strength of the connection between the skin 124 and the porous foam 126 is weaker than the adhesive bond between the skin 124 and the carrier 400. Thus, as the tape is peeled away, the skin 124 of the foam board tears off along with the adhesive 402. The resulting peel strength for the conventional system with conventional adhesive shown in FIG. 6 is from about 0.8 to about 2 pounds per inch width.

In contrast, FIG. 7 illustrates the improved adhesive system disclosed herein. In the FIG. 7 embodiment, the adhesive 402 and/or the substrate 400 are more pliable (or can be elongated more before failing) and/or are weaker than in the embodiment illustrated by FIG. 6. For example, in some exemplary embodiments, the improved adhesive system comprises an adhesive tape that may be adhered to an extruded polystyrene foam board. In some exemplary embodiments, the elongation of the adhesive tape is greater than or equal to about 300%, as measured per standard Pressure Sensitive Tape Council (PSTC) such as PSTC 131 Breaking Strength and Elongation of Pressure Sensitive Tapes. In some exemplary embodiments, the tensile strength is from about 2 pounds per inch width to about 10 pounds per inch width, or from about 4 pounds per inch width to about 8 pounds per inch width, as measured per standard PSTC methods such as PSTC 101 Peel Adhesion of Pressure Sensitive Tape. As a result of the increased pliability and elongation and/or the decreased strength of the adhesive 402, the adhesive 402 of the tape 12 shown in FIG. 7 stretches and pulls apart or “splits” upon failure, rather than maintaining a rigid adhesive bond. As such, the area A of force application that results from pulling or peeling the tape away from the foam board 10 is at least 25% wider than in the examples illustrated by FIGS. 5 and 6. Thus, as the tape is peeled away from the substrate, a portion of the adhesive remains on the foam board, and the skin 124 of the foam board remains attached to the porous foam 126. The resulting “split adhesive” failure mechanism of this pliable adhesive 402 system are found because the adhesive deforms and expands the area A of force across a larger area of the substrate. In some embodiments, the peel strength is from about 2.5 to about 5 pounds per inch width. Previously, this improved peel strength was only exhibited in butyl adhesives applied at a thickness between 15 and 20 mil. However, as discussed above, the improved adhesive system disclosed herein achieves this result at a substantially lower weight.

Table 1 below quantifies the effects on peel strength set forth above on certain exemplary embodiments of the improved adhesive system, as compared to a conventional adhesive system:

TABLE 1
Improved Peel Strength at Adhesive Thickness Less Than 5 mil

| | | Adhesive Thickness | Peel Force on Foam |
|---|---|---|---|
| Sample | Adhesive Type | (mil) | (lbs/in. width) |
| 1a | Conventional | 2 | 1.62 |
| 1b | Conventional | 3 | 1.81 |
| 1c | Conventional | 2 | 1.57 |
| 2a | Improved | 2 | 2.52 |
| 2b | Improved | 3 | 3.15 |
| 2c | Improved | 4 | 4.19 |

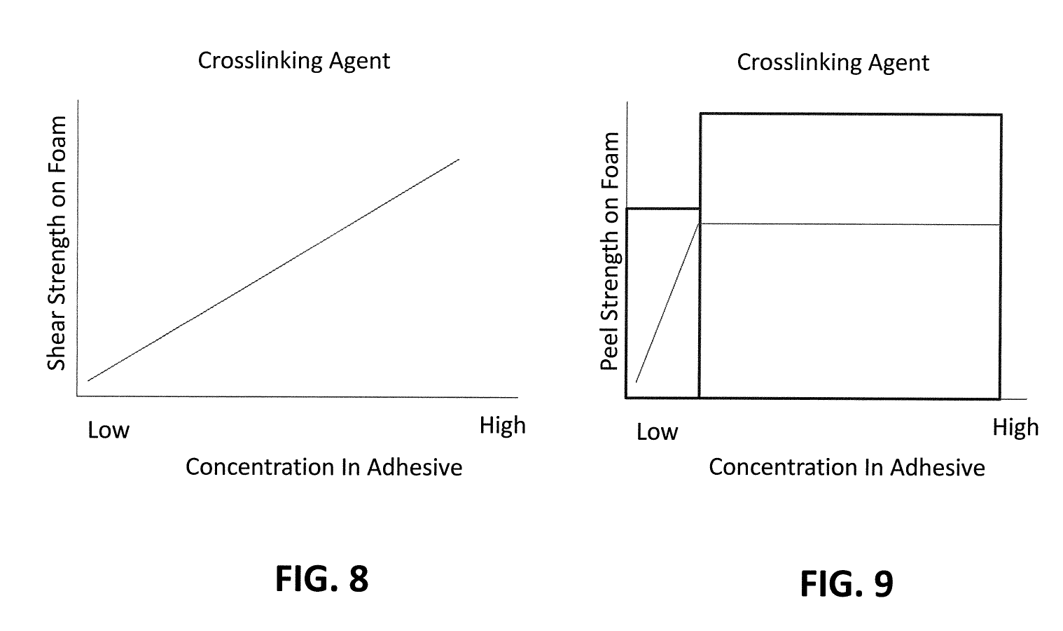

In some exemplary embodiments, the improved adhesive system includes one or more modifiers comprising a crosslinking agent, a tackifier, or both. The amount of modifier is tailored to achieve the desired split mechanism in the improved adhesive system. In conventional adhesive systems, the adhesives are highly crosslinked, which leads to an undesirable stiffness in the adhesive. As shown in FIGS. 8 and 9, shear properties increase with increasing crosslinking; however, at a certain concentration of crosslinking agent, peel properties undesirably plateau. At that particular transition point, the strength of the adhesive exceeds the strength of the substrate, which results in the substrate tearing seen in conventional adhesive systems.

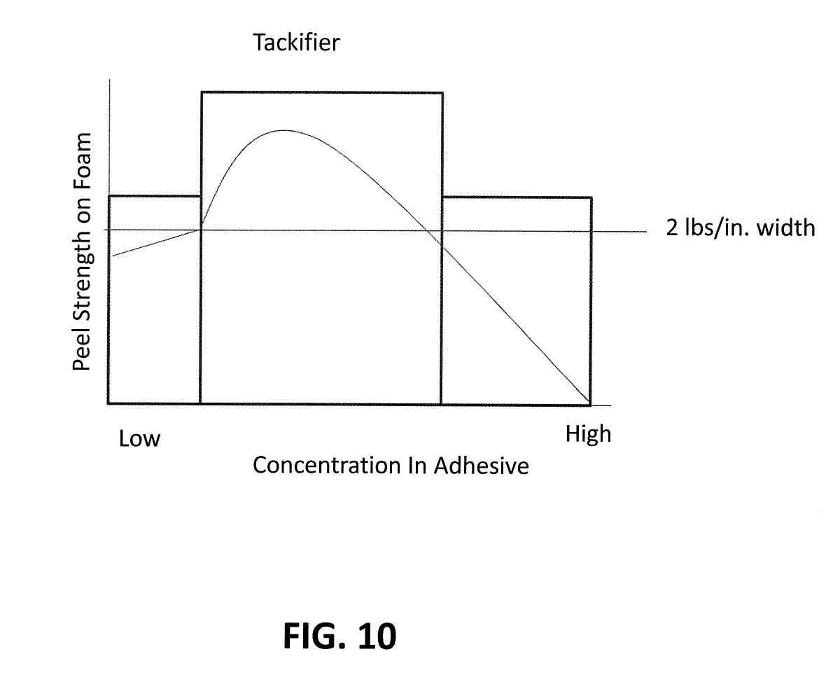

FIG. 10 illustrates the effect of the concentration of tackifier in the adhesive system. When concentrations of the tackifier are too low, the adhesive is overly stiff, which results in substrate tearing. Likewise, when the concentration of tackifier is too high, the adhesive is overly soft, and the cohesive split force is low. Within the desired range of the improved adhesive system disclosed herein, the concentration of the crosslinking agent and/or tackifer is tailored such that the adhesive exhibits a cohesive split within the adhesive upon failure, rather than tearing the substrate.

The applicability of the adhesive system disclosed herein is not limited to foam insulation board substrates. The system and method for increasing the level of adhesion of tapes may be applicable to other substrates including, but not limited to, other fragile materials such as other foams, lightly bonded particle board, or fiberglass veils and boards.

The inventive concepts have been described above both generically and with regard to various exemplary embodiments. Although the general inventive concepts have been set forth in what is believed to be exemplary illustrative embodiments, a wide variety of alternatives known to those of skill in the art can be selected within the generic disclosure.

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

What is claimed is:

1. A method of providing an air and moisture barrier system, the method comprising:
applying a butyl-based adhesive to a carrier material to form an adhesive carrier, wherein the butyl-based adhesive is applied in a thickness of less than or equal to about 5 mil;
providing a plurality of extruded polystyrene foam insulation boards; and
affixing the adhesive carrier to seal at least one side of each extruded polystyrene foam insulation board to one side of at least one other extruded polystyrene foam insulation board.

2. The method of claim 1, wherein the carrier material comprises a tape, polymeric film material, foil, paper, woven, nonwoven, veil, mat, or glass scrim.

3. The method of claim 1, wherein the adhesive carrier comprises a joint tape.

4. The method of claim 1, wherein the seal between the butyl-based adhesive and the extruded polystyrene foam insulation board provides a peel strength from about 2.5 to about 5 pounds per inch width.

5. A system comprising:
an extruded polystyrene foam board; and
an adhesive carrier bonded to a surface of the extruded polystyrene foam board, the adhesive carrier comprising a butyl-based adhesive layer affixed to a carrier material, wherein the butyl-based adhesive layer has a thickness of less than or equal to about 5 mil.

6. The system of claim 5, wherein the carrier material comprises a tape, polymeric film material, foil, paper, woven, nonwoven, veil, mat, or glass scrim.

7. The system of claim 5, wherein the adhesive carrier comprises an adhesive tape.

8. The system of claim 7, wherein the adhesive tape has an elongation greater than or equal to about 300%.

9. The system of claim 7, wherein the adhesive tape has a tensile strength from about 2 pounds per inch width to about 10 pounds per inch width.

10. The system of claim 9, wherein the adhesive tape has a tensile strength from about 4 pounds per inch width to about 8 pounds per inch width.
